(19) United States
(12) Patent Application Publication
(10) Pub. No.: US 2013/0000996 A1
(43) Pub. Date: Jan. 3, 2013

(54) MOBILE MACHINE WITH A SUPPORT SYSTEM

(75) Inventors: Nathan Wayne Miller, Plymouth, MN (US); John Eron Jorgensen, Andover, MN (US)

(73) Assignee: CATERPILLAR INC.

(21) Appl. No.: 13/173,936

(22) Filed: Jun. 30, 2011

(51) Int. Cl. B62D 11/20; B62D 55/06; B62D 3/00; B62D 55/00

(52) U.S. Cl. 180/9.46; 180/400

(57) ABSTRACT

A mobile machine includes a frame and a support system for supporting the frame from a ground surface underlying the support system. The support system may include a swing member pivotally engaged to the frame. The support system may also include journal structure rigidly attached to the swing member. The support system may further include a strut engaged to the journal structure in a manner allowing rotation of the strut relative to the journal structure about a central axis of the strut. Additionally, the support system may include a ground-engaging component mounted to the strut, the ground-engaging component being configured to move along the ground surface. The support system may also include a steering actuator engaged to the frame and the strut to control rotation of the strut about its central axis and thereby control a steering angle of the ground-engaging device relative to the frame.

### TECHNICAL FIELD

The present disclosure relates to mobile machines and, more particularly, to support systems of mobile machines.

### BACKGROUND

Many machines are mobile machines configured to perform one or more tasks while travelling along a ground surface like a road surface or a terrain surface of the earth. Such mobile machines often include a support system with one or more ground-engaging components (e.g., track units, wheels, or skids) configured to move along the ground surface, as well as one or more linkages for connecting the ground-engaging components to a frame of the machine. Some support systems include linkages configured to allow moving a ground-engaging component of the machine between laterally inward and laterally outward positions.

For example, Published German Patent Application No. DE 102004059881 to Boehme et al. (“the '881 application”) discloses various embodiments of pivoting linkages for connecting a wheel or a track to a frame of a roadworking vehicle. The pivoting linkages of the '881 application allow pivoting the wheel or track between extended and retracted positions. Additionally, the pivoting linkages of the '881 patent include one or more telescopic links that allow adjusting the geometry of the linkage.

Although the '881 application discloses pivoting linkages that may be used to move a wheel or track of a mobile machine between an extended and a retracted position, certain disadvantages may persist. For example, many of the linkages disclosed by the '881 application may have an unnecessarily large number of link members arranged in unnecessarily complicated manners.

The disclosed embodiments may solve one or more of the foregoing problems.

### SUMMARY

One disclosed embodiment relates to a mobile machine. The mobile machine may include a frame and a support system for supporting the frame from a ground surface underlying the support system. The support system may include a swing member pivotally engaged to the frame. The support system may also include journal structure rigidly attached to the swing member. The support system may further include a strut engaged to the journal structure in a manner allowing rotation of the strut relative to the journal structure about a central axis of the strut. Additionally, the support system may include a ground-engaging component mounted to the strut, the ground-engaging component being configured to move along the ground surface. The support system may also include a steering actuator engaged to the frame and the strut to control rotation of the strut about its central axis and thereby control a steering angle of the ground-engaging device relative to the frame.

Another embodiment relates to a mobile machine. The mobile machine may include a frame and a support system for supporting the frame from a ground surface underlying the support system. The support system may include a swing member pivotally engaged to the frame. The support system may also include a ground-engaging component pivotally engaged to the swing member, the ground-engaging component being configured to move along the ground surface. The support system may also include a first actuator connected to the swing member to pivot the swing member relative to the frame, the first actuator being disposed in a first plane. Additionally, the support system may include a second actuator operable to steer the ground-engaging component by pivoting the ground-engaging component relative to the swing member, the second actuator being disposed in a second plane.

A further disclosed embodiment relates to a method of supporting the frame of a mobile machine from a ground surface and steering the mobile machine along the ground surface. The method may include at least partially supporting the frame with a swing member pivotally engaged to the frame, the swing member being rigidly engaged to journal structure. The method may also include at least partially supporting the swing member with a strut engaged to the journal structure in a manner allowing rotation of the strut relative to the swing member about a central axis of the strut. Additionally, the method may include at least partially supporting the strut with a ground-engaging component mounted to the strut, the ground-engaging component being configured to move along the ground surface. The method may also include steering the ground-engaging component by controlling rotation of the ground-engaging component and the strut about a central axis of the strut with a steering actuator engaged to the frame and the strut.

### BRIEF DESCRIPTION OF THE DRAWINGS

FIG. 1 illustrates a side view of one embodiment of a machine and support system thereof according to the present disclosure;

FIG. 2 provides a detailed view of one portion of the support system shown in FIG. 1;

FIG. 3 provides a perspective view of the components shown in FIG. 2;

FIG. 4 provides a top view of the components shown in FIG. 3 in one operating state;

FIG. 5 provides a top view of the components shown in FIG. 4 in another operating state; and

FIG. 6 is a sectional view through line 6-6 of FIG. 4.

### DETAILED DESCRIPTION

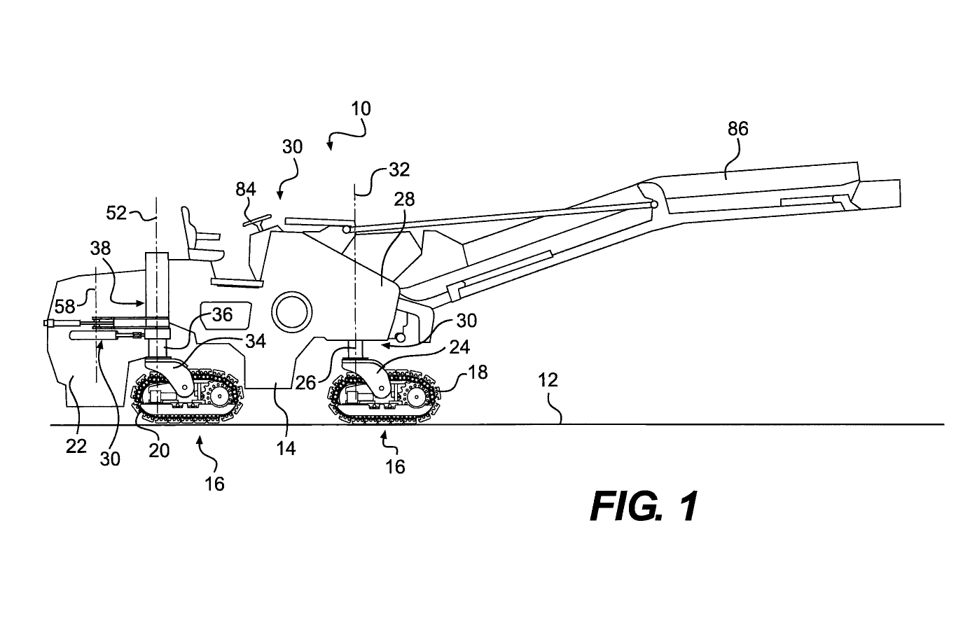

FIG. 1 illustrates one embodiment of a machine 10 according to the present disclosure. Machine 10 may be a mobile machine operable to move along a ground surface 12 underlying machine 12. Ground surface 12 may be a man-made surface, such as a road or parking lot, or ground surface 12 may be a terrain surface of the earth.

Machine 10 may be configured to perform various functions when travelling ground surface 12. In the embodiment shown in FIG. 1, machine 10 may be a cold planer or road reclaimer. In such an embodiment, machine 10 may be configured to grind a top layer of concrete, asphalt, or similar material off of ground surface 12.

Machine 10 may include a frame 14. Frame 14 may serve to tie together and support the other components and systems of machine 10. In addition to frame 14, machine 10 may have various other components and systems that serve various purposes. For example, where machine 10 is a cold planer or road reclaimer, machine 10 may include a grinding mechanism (not shown) configured to grind off a top layer of ground surface 12. Such a grinding mechanism may include, for example, a rotor (not shown) with cutting tools (not shown), such as teeth, for cutting and grinding the top layer of ground surface 12. Such a grinding mechanism may be disposed in various places on machine 10. For example, the grinding mechanism may be housed in a rear, lower portion 22 of machine 10. Alternatively or additionally, machine 10 may include one or more grinding mechanisms located in middle and/or forward positions. Machine 10 may also include a conveyor 86 configured to receive material removed from ground surface 12 by the grinding mechanism and convey that material to a receiver, such as a truck.

Machine 10 may also include one or more power sources (not shown) for powering the grinding mechanism, conveyor 86, and/or various other components and systems of machine 10. For example, machine 10 may include one or more internal combustion engines, batteries, fuel cells, or the like for providing power. Machine 10 may also include various provisions for transmitting power from such power sources to the grinding mechanism and/or various other components of the machine. For example, where machine 10 includes an internal combustion engine as a power source, machine 10 may include one or more mechanical or electrical power-transmission devices, such as, mechanical transmissions, hydraulic pumps and motors, and/or electric generators and motors, for transmitting power from the engine to the grinding mechanism and conveyor 86.

To support it from ground surface 12 and steer it as it moves along ground surface 12, machine 10 may include a support system 16 and a steering system 30. Support system 16 may include one or more front ground-engaging components 18 and one or more rear ground-engaging components 20 configured to move along ground surface 12. FIG. 1 shows a front ground-engaging component 18 on a right side of machine 10, as well as a rear ground-engaging component 20 on the right side of machine 10. Machine 10 may include similar front and rear ground-engaging components 18, 20 on a left side. Each ground-engaging component 18, 20 may include any device or devices configured to move across ground surface 12, including, but not limited to track units, wheels, and skids. FIG. 1 shows ground engaging components 18, 20 as track units.

Support system 16 may include various components connecting frame 14 to ground engaging components 18, 20 in a manner to support machine 10 from ground engaging components 18, 20. As FIG. 1 shows, in some embodiments, the components connecting front ground-engaging component 18 to frame 14 may include an undercarriage bracket 24 connected to ground engaging component 18, and a strut 26 connected to and extending up from undercarriage bracket 24. Strut 26 may be engaged to frame 14 directly or through one or more other components (not shown) in a manner allowing a front portion 28 of machine 10 to be supported by strut 26.

The engagement between strut 26 and frame 14 may also be such to allow rotation of strut 26, undercarriage bracket 24, and ground-engaging component 18 about a vertical axis 32 relative to frame 14. This rotation capability may allow steering ground-engaging component 18 and, thus, machine 10. Steering system 30 may have one or more actuators (not shown) for controlling the rotation of strut 26, undercarriage bracket 24, and ground-engaging component 18 about vertical axis 32.

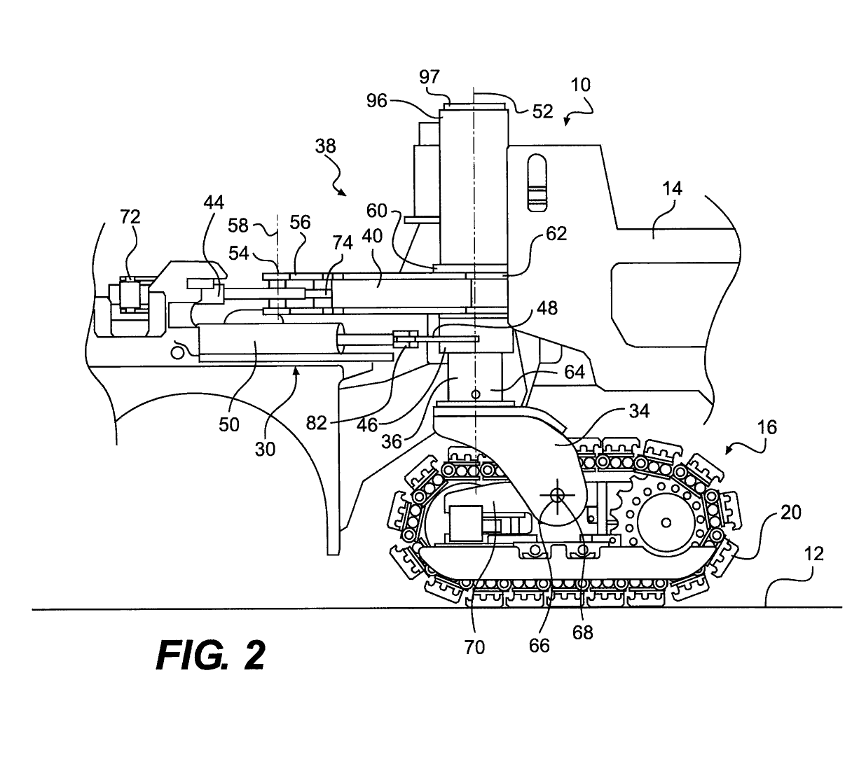

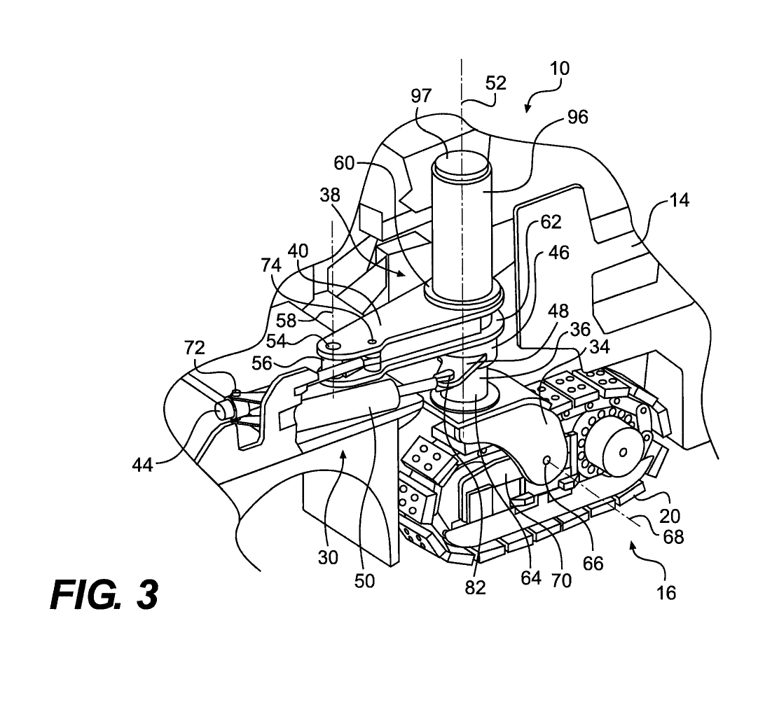

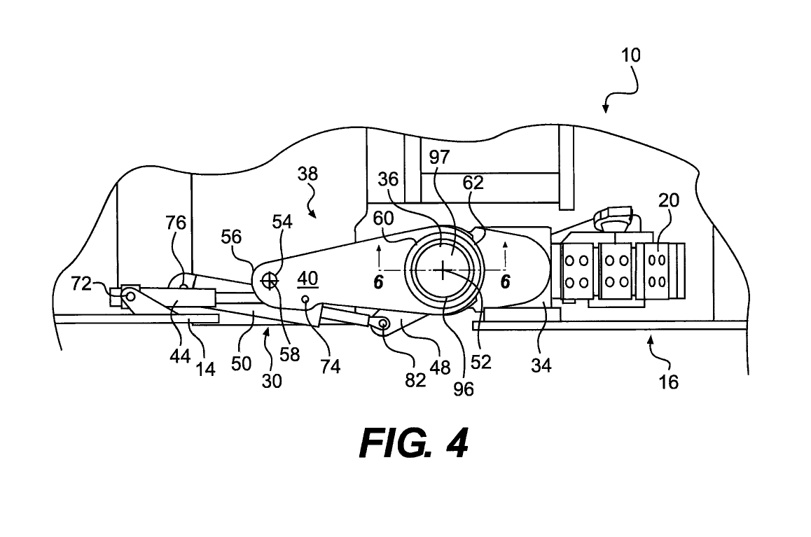

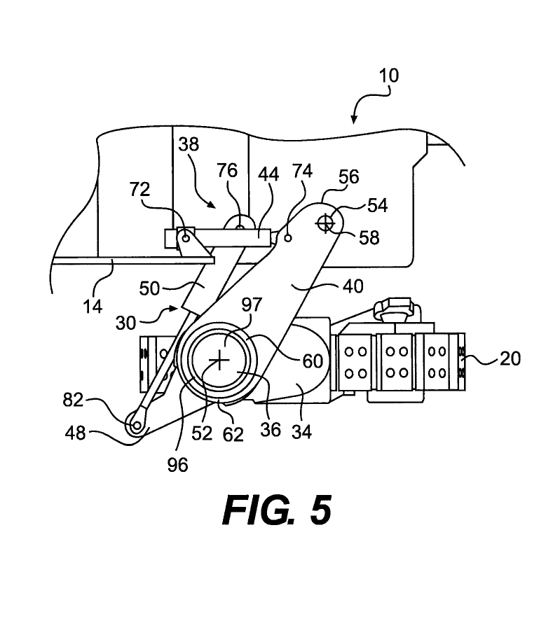

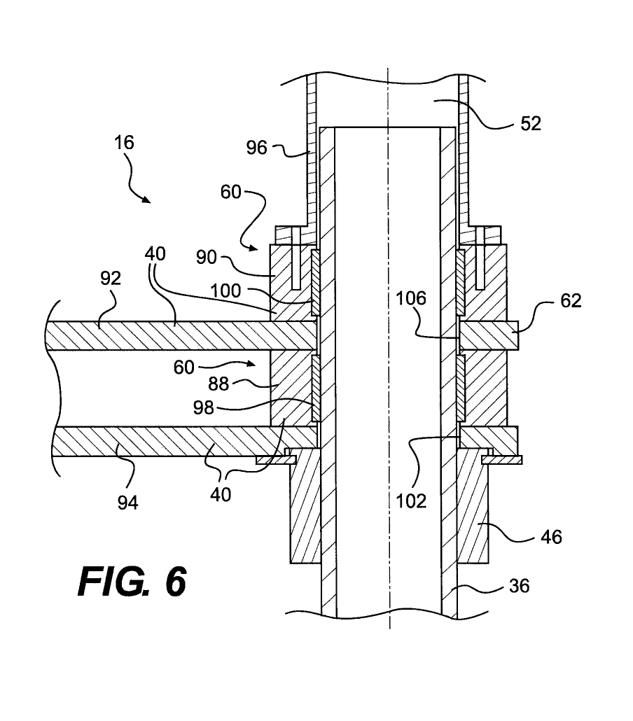

Similar to the components connecting front ground-engaging component 18 to frame 14, support system 16 may include an undercarriage bracket 34 and a strut 36 supported from rear ground-engaging component 20. Support system 16 may also include a linkage system 38 connecting strut 36 to frame 14. Details of linkage system 38, strut 36, undercarriage bracket 34, and rear ground-engaging component 20 can be better seen in FIGS. 2-6. To allow various aspects of these components to be better seen, FIGS. 2-5 omit all components of machine 10 except frame 14, linkage system 38, strut 36, undercarriage bracket 34, and rear ground-engaging component 20. FIG. 2 provides a close-up view of these components from the side. FIG. 3 provides perspective view of these components. FIG. 4 provides a top view of these components in one position. FIG. 5 provides a top view of these components in another position. FIG. 6 provides a sectional view through line 6-6 of FIG. 4.

Linkage system 38 may be configured to allow horizontal translation of rear ground-engaging component 20, as well as rotation of rear ground-engaging component 20 about a vertical axis 52 for steering purposes. FIG. 4 illustrates linkage system 38 positioned to hold ground-engaging component 20 in a laterally inboard position, and FIG. 5 illustrates linkage system 38 positioned to hold ground-engaging component 20 in a laterally outboard position. In some embodiments, linkage system 38 may include a swing member 40, journal structure, a swing actuator 44, a steering ring 46, a steering member 48, and a steering actuator 50

Linkage system 38 may be configured to transmit at least a portion of the weight carried by rear ground-engaging component 20 from frame 14, through swing member 40, strut 36, and undercarriage bracket 34, to ground-engaging component 20. As best shown in FIG. 3, to transmit weight and other loads from frame 14 to swing member 40, linkage system 38 may have swing member 40 engaged to frame 14 by a pin joint 54 at an inner end 56 of swing member 40. Outward of pin joint 54, swing member 40 may have an outer end 62. Swing member 40 may be a rigid member having a fixed length between its inner and outer ends 56, 62. Pin joint 54 may be configured to allow swing member 40 to rotate relative to frame 14 about a vertical axis 58, while constraining swing member 40 from translating or rotating in any other direction relative to frame 14. In other words, pin joint 54 may allow swing member 40 to rotate within a horizontal plane but prevent any other motion of swing member 40. This configuration may allow transmission of substantial loads between frame 14 and swing member 40 through pin joint 54, including transmission of vertical loads and substantial moments about any horizontal axis.

In some embodiments, machine 10 may include other features that may help transmit forces and loads between swing member 40 and frame 14. For example, machine 10 may include one more moveable locking pins (not shown) for selective connection between swing member 40 and frame 14 to restrain relative movement between swing member 40 and frame 14 in one or more manners. One such moveable locking pin may include a vertically extending pin attached to frame 14 at a position below swing member 40 and at a distance from axis 58. This locking pin may be configured to move vertically between a position disengaged from swing member 40 and a position engaged to swing member 40 (such as through a hole in swing member 40). When such a locking pin is disengaged from swing member 40, it may present no restriction on the motion of swing member 40. On the other hand, when such a locking pin is engaged to swing member 40, it may restrain swing member 40 from pivoting about axis 58. Additionally, when engaged to swing member 40, such a locking pin may also assist pin joint 54 in carrying vertical loads and/or moments about horizontal axes.

FIG. 6, a sectional view of swing member 40 through line 6-6 in FIG. 4, provides greater details of certain aspects of one possible configuration of swing member 40. In the example of FIG. 6, swing member 40 includes an upper plate 92, a lower plate 94, a ring 88, and a ring 90. Upper and lower plates 92, 94 may extend parallel to one another in vertically spaced horizontal planes. Upper plate 92 may include an opening 106 large enough for strut 36 to pass through. Opening 106 may be, for example, circular in shape and concentric with axis 52. Lower plate 94 may similarly include an opening 102 aligned with and substantially the same shape as opening 106.

Rings 88, 90 may be connected to upper and lower plates 92, 94. Ring 88 may be disposed between upper and lower plates 92, 94 adjacent outer end 62 of swing member 40. Ring 88 may be concentric with axis 52 and, thus, aligned with openings 102, 106. In some embodiments, ring 88 may be rigidly attached to both upper and lower plates 92, 94. For example, ring 88 may be welded to upper and lower plates 92, 94, rigidly fastened to upper and lower plates 92, 94, or integrally formed (e.g., cast) with upper and lower plates 92, 94. Ring 90 may be disposed above upper plate 92. Ring 90 may also be substantially concentric with axis 52 and, thus, aligned with openings 102 and 106. Additionally, ring 90 may be rigidly attached to upper plate 92. For example, ring 90 may be welded to upper plate 92, rigidly fastened to upper plate 92, or integrally formed (e.g., cast) with upper plate 92, 94. The opening in each of rings 88, 90 may be large enough for strut 36 to pass through them. In addition to upper and lower plates 92, 94 and rings 88, 90, swing member 40 may include various other components engaged to one another in various ways.

A tube 96 may be attached to outer end 62 of swing member 40. For example, tube 96 may be attached to ring 90, such as by fasteners. The interior bore of tube 96 may extend concentric with axis 52. Additionally, the interior bore of tube 96 may be large enough to receive strut 36. As best shown in FIGS. 2 and 3, an upper end of tube 96 may include a cap 97 covering the interior bore of tube 96. Cap 97 may limit movement of strut 36 along axis 52 within tube 96.

Like the engagement between frame 14 and swing member 40, the engagement between swing member 40 and strut 36 may allow transmission of substantial vertical loads and horizontal moments between swing member 40 and strut 36. For example, swing member 40 and strut 36 may be engaged to one another in a manner allowing strut 36 to rotate about vertical axis 52, which may coincide with a central axis of strut 36. FIG. 6 shows details of one embodiment of such an engagement between swing member 40 and strut 36. In this embodiment, linkage system 38 may include journal structure 60 that is rigidly engaged to swing member 40, and strut 36 may be engaged to journal structure 60 in a manner allowing rotation of strut 36 about axis 52 relative to journal structure 60.

Swing member 40, journal structure 60, and strut 36 may be constructed and engaged to one another in various ways that provide rigid connection of journal structure 60 to swing member 40 and rotational engagement of strut 36 to journal structure 60. Strut 36 may include a circular, vertically extending shaft rotatably engaged to journal structure 60. Journal structure 60 may be part of swing member 40 itself or a separate component attached to swing member 40. In the embodiment shown in FIG. 6, journal structure 60 is part of swing member 40 itself, specifically rings 88, 90 of swing member 40. Journal structure 60 may be engaged to strut 36 in various ways that constrains rotation of strut 36 to rotation about axis 52. In the embodiment shown in FIG. 4, journal structure 60 (i.e., rings 88, 90) may be engaged to strut 36 indirectly via bushings 98, 100 located in slots of rings 88, 90. Openings 102, 106 in upper and lower plates 92, 94, rings 88, 90, and bushings 98, 100 may encircle the outer surface of the shaft of strut 36. Bushings 98, 100 may contact the outer surface of the shaft of strut 36 and transmit loads between strut 36 and journal structure 60 in directions perpendicular to axis 52. Thus, through bushings 98, 100, journal structure 60 may be engaged to strut 36 in a manner allowing rotation of strut 36 about axis 52, while preventing rotation of strut 36 about horizontal axes. By preventing relative rotation between swing member 40 and strut 36 about horizontal axes, this configuration may allow transmission of substantial horizontal moments between swing member 40 and strut 36.

Strut 36 may also be connected to undercarriage bracket 34 in a manner allowing transmission of substantial vertical loads and horizontal moments between the two. For example, a lower end 64 of strut 36 may be rigidly engaged to undercarriage bracket 34. This fixed engagement may be effected by any suitable means, including welding, fasteners, and/or integral construction.

Undercarriage bracket 34 may be connected to ground-engaging component 20 in various ways that allow transfer of weight and horizontal forces and moments between the two components. For example, as best shown in FIGS. 2 and 3, undercarriage bracket 34 may connect to ground-engaging component 20 via a pin joint 66 that allows relative rotation about a horizontal axis 68 transverse to the direction of travel, while restraining relative movement between undercarriage bracket 34 and ground-engaging component 20 in other directions. Pin joint 66 may connect undercarriage bracket 34 to a center frame 70 of ground-engaging component 20. By preventing relative vertical and horizontal translation between undercarriage bracket 34 and ground-engaging component 20, pin joint 66 may transmit vertical loads (such as a portion of the weight of machine 10) and horizontal loads between undercarriage bracket 34 and ground-engaging component 20. By allowing pivoting about axis 68, pin joint 66 may allow ground-engaging component 20 to pivot fore and aft to conform to localized inclines and declines in ground surface 12.

The configuration of linkage system 38 shown in the figures and discussed above may allow undercarriage bracket 34, strut 36, journal structure 60, and swing member 40 to bear most of the loads on ground-engaging component 20 without substantial assistance from any other components. Because each of the joints between these structures can transmit moments about horizontal axes, these structures may be able to support the horizontal moments that arise from transmitting the weight of machine 14 between inner end 56 of swing member 40 and ground-engaging component 20. Also due to their ability to carry moments about horizontal axes, the joints between these structures may be able to support horizontal moments arising from transmission of horizontal forces from ground-engaging component 20 to inner end 56 of swing member 40. Because of the substantial length of swing member 40 and strut 36, these horizontal moments may be particularly large at the connection between swing member 40 and strut 36. Advantageously, the disclosed robust, rigid connection between swing member 40 and journal structure 60 may allow transmission of such large moments through strut 36 and swing member 40 to frame 14.

With swing member 40, journal structure 60, strut 36, and undercarriage component 34 addressing all horizontal moments, swing actuator 44 and steering actuator 50 may address moments about vertical axes 58 and 52, respectively. Swing actuator 44 may be any type of component configured and engaged to machine 10 in a manner allowing it to control the rotation of swing member 40 around vertical axis 58. For example, as best shown in FIGS. 3-5, swing actuator 44 may be a hydraulic cylinder pivotally engaged to frame 14 and pivotally engaged to swing member 40. Swing actuator 44 may pivotally engage frame 14 via a pin joint 72 that allows relative rotation about a vertical axis. Similarly, swing actuator 44 may pivotally engage frame 14 via a pin joint 74 that allows relative rotation about a different vertical axis. Accordingly, by extending and retracting, swing actuator 44 may rotate swing member 40 in a horizontal plane about vertical axis 58. By doing so, swing actuator 44 may move swing member 40 and ground-engaging component 20 between the laterally inner position shown in FIG. 4 and the laterally outer position shown in FIG. 5. In addition to swing actuator 44, machine 10 may also include other components that help resist moments on swing member 40 about axis 58. For example, as discussed in greater detail above, machine 10 may include one or more moveable locking pins that selectively engage swing member 40 at a distance from axis 58. Such locking pins may substantially reduce loads on swing actuator 44 when engaged to swing member 40.

Steering actuator 50 may be configured and engaged to machine 10 in any manner allowing steering actuator 50 to control the angular orientation of strut 36 about vertical axis 52. In some embodiments, steering actuator 50 may be a hydraulic cylinder connected between frame 14 and strut 36. As best shown in FIGS. 4 and 5, steering actuator 50 may pivotally connect to frame 14 via a pin joint 76 that allows relative rotation about a vertical axis. Steering actuator 50 may connect to strut 36 via steering ring 46 and a steering member 48, which may be attached to strut 36 in a manner preventing rotation of steering ring 46 and steering member 48 relative to strut 36. Steering actuator 50 may connect to steering member 40 via a pin joint 82 that allows relative rotation about a vertical axis. Thus, by extending and retracting, steering actuator 50 may rotate strut 36, undercarriage 34, and ground-engaging component 20 about vertical axis 52, thereby steering ground-engaging component 20 and machine 10. As best shown in FIGS. 2 and 3, steering actuator 50 may occupy and move within one horizontal plane, and swing actuator 44 may occupy and move within a different horizontal plane.

The orientation of swing member 40 and the steering angle of ground-engaging component 20 may interrelate in manners that depend on the geometric relationships between the lengths of the various members and actuators and the locations of the various pin joints and axes of linkage system 38. The disclosed approach of connecting steering actuator 50 directly to frame 14 may enable configuring the geometry of linkage system 38 in a manner that reduces steering angle disturbances resulting from movement of swing member 40. For example, as best shown in FIGS. 4 and 5, the disclosed geometry of linkage system 38 provides the same steering angle of ground-engaging component 20 in the laterally inner and outer positions of swing member 40 without moving steering actuator 50. In other words, if steering actuator 50 is held at the same length when swing actuator 44 is activated to move swing member 40 between the laterally inner and outer positions of FIGS. 4 and 5, the resulting steering angle of ground-engaging component 20 is the same at the laterally inner and outer positions.

While FIGS. 1-5 show a linkage system 38 for a right, rear ground-engaging component 20 of machine 10, machine 10 may have a similar ground-engaging component and linkage system on a left, rear corner of machine 10. In some embodiments, the configuration of such a ground-engaging component and linkage system on the left, rear side of machine 10 may substantially mirror the configuration of the ground-engaging component 20 and linkage system 38 shown in FIGS. 1-5.

Machine 10 may include various components for controlling swing actuator 44 and steering actuator 50 to control the lateral position and steering angle of ground-engaging component 20. To receive operator inputs regarding a desired position and steering angle of ground-engaging components, machine 10 may include one or more operator-input devices. For example, as FIG. 1 shows, machine 10 may include a steering input 84 (such as a steering wheel) that an operator may manipulate to signal desired steering changes. Similarly, machine 10 may include an operator-input device (not shown) with which an operator can request inward or outward lateral movement of ground-engaging component 20. Machine 10 may include various control components (not shown) operatively connected between such operator input devices and linkage system 38 to activate swing actuator 44 and/or steering actuator 50 to effect lateral movement and/or steering changes requested by an operator. For example, where swing actuator 44 and steering actuator 50 are hydraulic cylinders, machine 10 may include a power source (not shown) that drives a hydraulic pump (not shown) and one or more hydraulic valves (not shown) that control delivery of hydraulic fluid from the hydraulic pump to swing actuator 44 and steering actuator 50.

In addition to the components and systems mentioned above, machine 10 may have various other components and systems. For example, machine 10 may include a propulsion system for moving it along ground surface 12. In some embodiments, such a propulsion system may include one or more components for driving ground-engaging components 18, 20 to propel machine 10. For instance, where machine 10 includes a hydraulic pump (not shown) driven by a power source (not shown), machine 10 may include one or more hydraulic motors (not shown) drivingly connected to ground-engaging components 18, 20 to propel machine 10.

Machine 10 and support system 16 are not limited to the configuration shown in FIGS. 1-6. For example, swing member 40, journal structure 60, and strut 36 may be configured and engaged to one another in different manners than shown in the figures. Journal structure 60 may be indirectly engaged to strut 36 via components other than bushings 98, 100. For instance, roller bearings or the like may be used in place of bushings 98, 100. Alternatively, journal structure 60 may directly engage strut 36 without bushings 98, 100 or any other component disposed between journal structure 60 and strut 36. Additionally, journal structure 60 may have a different configuration than shown in the figures. For example, in some embodiments, journal structure 60 could be part of upper and lower plates 92, 94 of swing member 40. Alternatively, in lieu of being part of swing member 40 itself, journal structure 60 may be a separate component rigidly attached to swing member 40, such as by welding, fastening, or the like. Similarly, other structures of linkage system 38 may be constructed and engaged to one another in different manners. Additionally, linkage system 38 may include additional components. Furthermore, linkage system 38 and ground-engaging component 20 may be mounted in different locations on machine 10.

### INDUSTRIAL APPLICABILITY

Machine 10 and support system 16 may have use in any application where one or more tasks may be performed by moving machine 10 along ground surface 12. For example, where machine 10 is a cold planer or a road reclaimer, machine 10 may have use for grinding a layer of asphalt, concrete, or the like off of ground surface 12. This may be done, for example, in preparation to lay a new cover of asphalt, concrete, or the like.

While operating machine 10 to grind a layer of material from ground surface 12, an operator may control the propulsion system to move machine 10 forward, while manipulating steering input 84 to control the direction machine 10 travels. Based on the operator's manipulation of steering input 84, steering system 30 may control the rotation of front ground-engaging component 18 about vertical axis 32 and/or the rotation of rear ground-engaging component 20 about vertical axis 52. Referring to FIG. 4, steering system 30 may, for example, move the rear of machine 10 toward the left by extending steering actuator 50 to rotate strut 36, undercarriage bracket 34, and ground-engaging component 20 counterclockwise (as viewed from above) about vertical axis 52. Conversely, steering system 30 may move the rear of machine 10 toward the right by contracting steering actuator 50 to rotate strut 36, undercarriage bracket 34, and ground-engaging component 20 clockwise (as viewed from above) about vertical axis 52. Steering system 30 may coordinate such pivoting of rear ground-engaging component 20 with appropriate pivoting of front ground-engaging component 18 to provide the desired steering indicated by the operator's manipulation of steering input 84.

While machine 10 is moving forward with steering system 30 controlling the direction of ground-engaging components 18, 20, rear ground-engaging component 20 may be positioned in the laterally inner position shown in FIG. 4 or the laterally outer position shown in FIG. 5. To position ground-engaging component 20 in the laterally inner position of FIG. 4, swing actuator 44 may be extended to rotate swing member 44 counterclockwise (as viewed from above). In the laterally inner position, ground-engaging component 20 may be disposed inward of an outer side of frame 44 of machine 10. This may allow operating the outer side of frame 44 closer to objects projecting upward from ground surface 12, which may facilitate grinding the top layer of ground surface 12 flush with such upstanding objects.

To position ground-engaging component 20 in the laterally outer position shown in FIG. 5, swing actuator 44 may be contracted to rotate swing member clockwise (as viewed from above). Operating machine 10 with ground-engaging component 20 in the laterally outer position of FIG. 5 may give machine 10 a wider base. This may provide greater stability.

As noted above, steering actuator 50 may be engaged to frame 14 and steering member 48 in positions such that a given length of steering actuator 50 provides the same steering angle of ground-engaging component 20 in the laterally inner and laterally outer position. For example, steering actuator 50 has the same length in both FIGS. 4 and 5, and ground-engaging component 20 has the same steering attitude in FIGS. 4 and 5, specifically straight forward. Thus, when swing actuator 44 is activated to move ground-engaging component 20 from the laterally inner position to the laterally outer position or vice-a-versa, no change in the steering actuator 50 is required to maintain the same steering angle. This may help simplify control of steering actuator 50 by obviating adjustments based on the position of swing member 40.

The disclosed configurations of linkage system 38 may also provide a number of other advantages. For example, the ability of linkage system 38 to transfer substantially all horizontal moments to frame 14 through a single member, specifically swing member 40, may promote simplicity of linkage system 38 by obviating the use of other rigid members to help carry these horizontal moments. Additionally, placing swing member 40 and swing actuator 44 in one horizontal plane, and placing steering actuator 50 and steering member 48 in another horizontal plane may help save space on machine 10. As shown in FIGS. 4 and 5, putting these components in different horizontal planes may allow them to overly one another, which may help make linkage system 38 laterally compact.

Operation of support system 16 and steering system 30 are not limited to the examples discussed above. For example, while the foregoing discusses moving the rear of machine 10 to the left by contracting steering actuator 50 and moving machine 10 to the right by extending steering actuator 50, these movements may be reversed in some embodiments having different positioning and geometries of steering member 48 and steering actuator 50. Similarly, while the examples discussed above include extending swing actuator 44 to position swing member 40 in the laterally inner position and contracting swing actuator 44 to position swing member 40 in the laterally outer position, these movements may be reversed in embodiments having different positioning and/or geometry of swing member 40 and swing actuator 44.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the systems and methods disclosed herein. It is intended that the specification and examples be considered as exemplary only, with a true scope of the disclosure being indicated by the following claims and their equivalents.

What is claimed is:

1. A mobile machine, comprising:
a frame;
a support system for supporting the frame from a ground surface underlying the support system, the support system including:
a swing member pivotally engaged to the frame,
journal structure rigidly attached to the swing member,
a strut engaged to the journal structure in a manner allowing rotation of the strut relative to the journal structure about a central axis of the strut,
a ground-engaging component mounted to the strut, the ground-engaging component being configured to move along the ground surface, and
a steering actuator engaged to the frame and the strut to control rotation of the strut about its central axis and thereby control a steering angle of the ground-engaging device relative to the frame.

2. The mobile machine of claim 1, wherein the journal structure is part of the swing member.

3. The mobile machine of claim 2, wherein the journal structure is engaged to the strut via at least one component disposed between the journal structure and the strut.

4. The mobile machine of claim 3, wherein the at least one component disposed between the journal structure and the strut includes a bushing.

5. The mobile machine of claim 1, wherein the journal structure is engaged to the strut via at least one component disposed between the journal structure and the strut.

6. The mobile machine of claim 5, wherein the at least one component disposed between the journal structure and the strut includes a bushing.

7. The mobile machine of claim 1, wherein the swing member surrounds a shaft of the strut.

8. The mobile machine of claim 1, further comprising a second actuator connected between the frame and the swing member to pivot the swing member relative to the frame.

9. The mobile machine of claim 8, wherein:
the steering actuator is disposed in a first plane; and
the second actuator is disposed in a second plane.

10. The mobile machine of claim 8, wherein the second actuator is operable to move the swing member, the strut, and the ground-engaging component between a laterally inner position and a laterally outer position by rotating the swing member relative to the frame.

11. The mobile machine of claim 10, wherein the steering actuator is connected to the frame in such a position that, for a given length of the steering actuator, the steering angle of the ground-engaging component is the same in the laterally inner position and the laterally outer position.

12. The mobile machine of claim 1, wherein the mobile machine is a cold planer or road reclaimer.

13. A mobile machine, comprising:
a frame;
a support system for supporting the frame from a ground surface underlying the support system, the support system including:
a swing member pivotally engaged to the frame;
a ground-engaging component pivotally engaged to the swing member, the ground-engaging component being configured to move along the ground surface,
a first actuator connected to the swing member to pivot the swing member relative to the frame, the first actuator being disposed in a first plane,
a second actuator operable to steer the ground-engaging component by pivoting the ground-engaging component relative to the swing member, the second actuator being disposed in a second plane.

14. The mobile machine of claim 13, wherein the first actuator is operable to move the swing member, the strut, and the ground-engaging component between a laterally inner position and a laterally outer position by rotating the swing member relative to the frame.

15. The mobile machine of claim 14, wherein the second actuator is connected to the frame in such a position that, for a given length of the steering actuator, the steering angle of the ground-engaging component is the same in the laterally inner position and the laterally outer position.

16. The mobile machine of claim 13, wherein the ground-engaging component is a track unit.

17. The mobile machine of claim 13, wherein the ground-engaging component is a wheel.

18. A method of supporting the frame of a mobile machine from a ground surface and steering the mobile machine along the ground surface, the method including:
at least partially supporting the frame with a swing member pivotally engaged to the frame, the swing member being rigidly engaged to journal structure;
at least partially supporting the swing member with a strut engaged to the journal structure in a manner allowing rotation of the strut relative to the swing member about a central axis of the strut;
at least partially supporting the strut with a ground-engaging component mounted to the strut, the ground-engaging component being configured to move along the ground surface; and
steering the ground-engaging component by controlling rotation of the ground-engaging component and the strut about a central axis of the strut with a steering actuator engaged to the frame and the strut.

19. The method of claim 18, further comprising moving the swing member between a laterally inner position and a laterally outer position with a second actuator engaged to the frame and the swing member.

20. The method of claim 19, wherein:
controlling rotation of the ground-engaging component and the strut about the central axis of the strut with the steering actuator includes moving the steering actuator within a first plane; and
moving the swing member between a laterally inner position and a laterally outer position with a second actuator includes moving the second actuator within a second plane.
